(19) United States
(12) Patent Application Publication
(10) Pub. No.: US 2012/0109562 A1
(43) Pub. Date: May 3, 2012

(54) ROTATIONAL ANGLE DETECTION DEVICE

(75) Inventors: Michisada Yabuguchi, Kasugai-shi (JP); Tsuyoshi Tada, Kasugai-shi (JP)

(73) Assignee: OMRON AUTOMOTIVE ELECTRONICS CO., LTD., Aichi (JP)

(21) Appl. No.: 13/282,951

(22) Filed: Oct. 27, 2011

(30) Foreign Application Priority Data
Oct. 27, 2010 (JP) 2010-240735

(51) Int. Cl. G01C 25/00; G06F 19/00

(52) U.S. Cl. 702/87

(57) ABSTRACT

A rotational angle detection device has a resolver in which an excitation coil, a first output coil and a second output coil are provided on a periphery of a rotor coupled to a rotation shaft, an excitation signal generator circuit that generates an excitation signal and sends the excitation signal to the excitation coil, and a rotational angle calculation unit that performs sampling for respective output signals of the first output coil and the second output coil in a predetermined cycle, and calculates a rotational angle of the rotation shaft based on two sampling signals obtained as a result of the sampling. The excitation signal generator circuit is of a single excitation mode and generates a single excitation signal.

### BACKGROUND OF THE INVENTION

1. Technical Field

The present invention relates to a device that detects a rotational angle of a motor and the like by using a resolver, and particularly, to a rotational angle detection device of a single excitation mode, which uses a single excitation circuit.

2. Related Art

A resolver is a rotational angle sensor including an excitation coil and two output coils on a periphery of a rotor coupled to a shaft. As such a rotational angle sensor, there is a rotary encoder besides the resolver. However, the rotary encoder uses an optical element and a magnetic resistance element, and accordingly, is prone to be affected by temperature, noise, dust and the like, and is inferior in terms of environmental resistance. As opposed to this, the resolver is basically composed only of coils and an iron core, and does not use the elements as described above. Accordingly, the resolver can be used even under severe environmental conditions, and for example, is used for detecting rotational angles of a motor and a steering wheel in an automobile.

When a sine wave signal is applied to the excitation coil of the resolver, then in the respective output coils, two-phase voltages amplitude-modulated into a sine wave shape are induced in response to a rotational angle of the shaft. Specifically, a signal in which a peak value of an amplitude is changed in accordance with a sin function is outputted from one of the output coils, and a signal in which a peak value of an amplitude is changed in accordance with a cos function is outputted from the other output coil. Hence, the amplitudes of the respective output signals are detected in a predetermined cycle, and tan⁻¹ thereof is obtained, whereby the rotational angle of the shaft can be calculated.

FIG. 6 is a block diagram of a rotational angle detection device using the resolver. A rotational angle detection device 100 is composed of a resolver 1 and a control unit 50. The resolver 1 includes a primary-side excitation coil L1 and secondary-side output coils L2 and L3. These coils L1 to L3 are arranged on a periphery of a rotor 11.

FIG. 7 is a view showing a schematic structure of the resolver 1. The rotor 11 is coupled to a shaft 13, and rotates together with the shaft 13. The shaft 13 is a rotation shaft of a motor and the like, or a shaft coupled thereto. On the periphery of the rotor 11, a stator 12 is provided. In the stator 12, magnetic poles (not shown) are formed at an equal interval over a circumferential direction, and around the magnetic poles, coils L (L1 to L3 are collectively shown by reference symbol L) are wound.

The resolver 1 shown here is a resolver of a variable reluctance type. A shape of the rotor 11 is designed so that a reluctance (magnetic resistance) in a gap between the rotor 11 and the stator 12 can be periodically changed in response to a rotational angle of the rotor 11, and that voltages amplitude-modulated in the sine wave shape can be induced in the output coils L2 and L3. Here, the rotor 11 has an ellipsoidal shape, and for a while the rotor 11 is making one rotation, voltages, which are equivalent to two cycles and are amplitude-modulated into the sine wave shape, are taken out of the output coils L2 and L3. As shapes of the rotor 11, besides this, there are a variety of shapes such as a cross.

The control unit 50 includes a CPU 51, an excitation circuit 52, and a signal amplifier circuit 55. The excitation circuit 52 generates an excitation signal composed of a sine wave signal sin (cot) as shown in FIG. 8A, and gives this excitation signal to the excitation coil L1. When the rotor 11 rotates, a signal as shown in FIG. 8B, in which a peak value of an amplitude is changed in accordance with the sin function, (hereinafter, referred to as a “sin signal”) is outputted from the output coil L2. This signal is represented by α·sin(θ)·sin(ωt). Here, α is a signal transformation ratio of the resolver 1, and θ is the rotational angle of the rotor 11 (shaft 13). Moreover, a signal as shown in FIG. 8C, in which a peak value of an amplitude is changed in accordance with the cos function, (hereinafter, referred to as a “cos signal”) is outputted from the output coil L3. This signal is represented by α·cos(θ)·sin(ωt).

The sin signal outputted from the output coil L2 is amplified by the signal amplifier circuit 55, and becomes a signal, which is as shown in FIG. 8D and is represented by β·α·sin(θ)·sin(ωt). Moreover, the cos signal outputted from the output coil L3 is amplified by the signal amplifier circuit 55, and becomes a signal, which is as shown in FIG. 8E and is represented by β·α·cos(θ)·sin(ωt). Here, β is an amplification factor of the signal amplifier circuit 55. The respective amplified signals are inputted to the CPU 51.

In the CPU 51, for the inputted sin signal and cos signal, sampling is performed in a predetermined cycle. As a result, for the sin signal, a sampling signal, which is as shown in FIG. 8F and is represented by β·α·sin(θ), is extracted, and for the cos signal, a sampling signal, which is as shown in FIG. 8G and is represented by β·α·cos(θ), is extracted. The CPU 51 arithmetically operates a ratio of amplitude values of the two sampling signals, that is, sin (θ)/cos(θ)=tan(θ) at every sampling point of time. Then, based on a result of this arithmetic operation, the CPU 51 detects a rotational angle θ from θ=tan⁻¹ [sin(θ)/cos(θ)].

Incidentally, as an excitation mode of the resolver, a double excitation mode has been general heretofore. In the double excitation mode, in the excitation circuit 52, there are provided: an excitation signal generator circuit that generates the excitation signal; and an inverted excitation signal generator circuit that generates an inverted excitation signal different from the excitation signal in phase by 180° (for example, refer to Japanese Unexamined Patent Publication No. 2008-304326).

FIG. 9 is a block diagram of a rotational angle detection device 200 using the double excitation mode. In FIG. 9, the same reference numerals are assigned to the same portions as those in FIG. 6. An excitation circuit 52 is composed of an excitation signal generator circuit 53 and an inverted excitation signal generator circuit 54. An excitation signal generated by the excitation signal generator circuit 53 is given to one end of an excitation coil L1 of a resolver 1 through a terminal T1, and an inverted excitation signal generated by the inverted excitation signal generator circuit 54 is given to other end of the excitation coil L1 through a terminal T2. The excitation signal and the inverted excitation signal have the same amplitude but different phases from each other by 180°. A signal formed by synthesizing these is applied to the excitation coil L1.

A signal amplifier circuit 55 is composed of a sin signal amplifier circuit 56 and a cos signal amplifier circuit 57. The sin signal amplifier circuit 56 amplifies a sin signal to be inputted from an output coil L2 to terminals T3 and T4. The cos signal amplifier circuit 57 amplifies a cos signal to be inputted from an output coil L3 to terminals T5 and T6. A detection method of the rotational angle in a CPU 51 is the same as that described with reference to FIG. 6.

In the above-mentioned rotational angle detection device 200 of the double excitation mode, for the excitation circuit 52, two circuits are required, which are the excitation signal generator circuit 53 and the inverted excitation signal generator circuit 54. Accordingly, cost is increased. Moreover, in Japanese Unexamined Patent Publication No. H03-56818 (published in 1991), a resolver is described, which excites, by signals different in phase from each other, the respective two salient poles in a pair of excitation salient poles having coils wound differentially, and then detects the rotational angle based on synthesized signals outputted from midpoints of the respective coils. However, even in this mode, a plurality of signal sources which generate the signals different in phase are required.

### SUMMARY

One or more embodiments of the present invention provides a rotational angle detection device that reduces cost thereof by simplifying an excitation circuit. One or more embodiments of the present invention provides a rotational angle detection device capable of detecting an angle accurately even in the case where offsets occur in signals to be outputted from output coils.

In accordance with one aspect of the present invention, there is provided a rotational angle detection device including:

a resolver in which an excitation coil, a first output coil and a second output coil are provided on a periphery of a rotor coupled to a rotation shaft;

an excitation signal generator circuit that generates an excitation signal and gives the excitation signal to the excitation coil; and

a rotational angle calculation unit that performs sampling for respective output signals of the first output coil and the second output coil in a predetermined cycle, and calculates a rotational angle of the rotation shaft based on two sampling signals obtained as a result of the sampling,

wherein the excitation signal generator circuit is composed of an excitation signal generator circuit of a single excitation mode, the excitation signal generator circuit generating a single excitation signal. Moreover, an offset correction unit is provided, the offset correction unit correcting, for the respective sampling signals, offsets contained in the respective output signals of the first output coil and the second output coil. The rotational angle calculation unit calculates the rotational angle based on the respective sampling signals in which the offsets are corrected by the offset correction unit.

In such a way, a circuit configuration is simplified by the single excitation mode using the one excitation signal generator circuit, and accordingly, the cost can be reduced. Moreover, the correction for the offsets contained in the output signals from the first output coil and the second output coil is performed, and as a result, even in the case of adopting the single excitation mode, an accurate rotational angle can be detected by the rotational angle calculation unit without being affected by the offsets.

In the present invention, the offset correction unit may include a storage unit in which an offset correction value for correcting the offsets is stored in advance.

In such a way, the offset correction value is preset in the storage unit, and accordingly, it is not necessary to arithmetically operate and calculate the correction value every time, and processing in the rotational angle calculation unit is reduced.

In place of the storage unit, the offset correction unit may include an arithmetic operation unit that arithmetically operates an offset correction value for correcting the offsets.

In such a way, the offset correction value is obtained by the arithmetic operation, and accordingly, it is not necessary to store the correction value in the storage unit in advance. Moreover, the offset correction value is not a fixed value, but is updated in real time. Accordingly, the offsets can be removed more effectively, and accuracy in the angle detection is enhanced.

In an embodiment of the present invention, the offset correction value is an average value of a first amplitude value at first timing when amplitudes of the two sampling signals become equal to each other and a second amplitude value at second timing when the amplitudes of the two sampling signals become equal to each other.

In such a way, the points of intersection of the respective sampling signals at two pieces of timing are detected, whereby an optimal offset correction value can be calculated with ease.

In accordance with one or more embodiments of the present invention, the circuit configuration is simplified by the adoption of the single excitation mode, and accordingly, the rotational angle detection device can be provided, which is capable of reducing the cost, and In addition, of detecting the accurate rotational angle without being affected by the offsets.

### BRIEF DESCRIPTION OF THE DRAWINGS

FIG. 1 is a block diagram of a rotational angle detection device according to a first embodiment of the present invention;

FIG. 2 is a circuit diagram showing a specific example of an excitation signal generator circuit;

FIG. 3 is a circuit diagram showing a specific example of a signal amplifier circuit;

FIG. 4 is a graph showing changes of sampling signals in one cycle;

FIG. 5 is a block diagram of a rotational angle detection device according to a second embodiment of the present invention;

FIG. 6 is a block diagram of a general rotational angle detection device;

FIG. 7 is a view showing a schematic structure of a resolver;

FIGS. 8A to 8G are views showing signal waveforms in the respective units of FIG. 6;

FIG. 9 is a block diagram of a rotational angle detection device of a double excitation mode;

FIG. 10 is a circuit diagram for explaining an influence of a line capacity;

FIGS. 11A and 11B are waveform charts for explaining an offset;

FIGS. 12A and 12B are views explaining an angle error in a case of a double excitation mode; and

FIGS. 13A and 13B are views explaining an angle error in a case of a single excitation mode.

### DETAILED DESCRIPTION

Hereinafter, embodiments of the present invention will be described with reference to the drawings. In the respective drawings, the same reference numerals are assigned to the same portions or corresponding portions. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

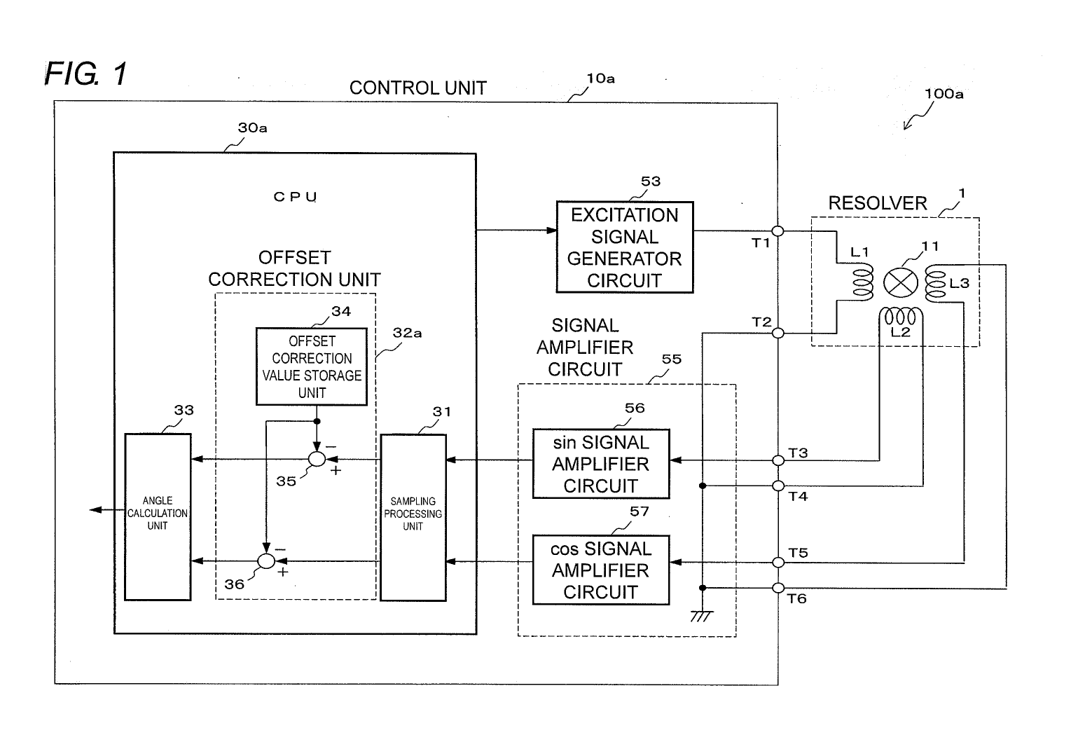

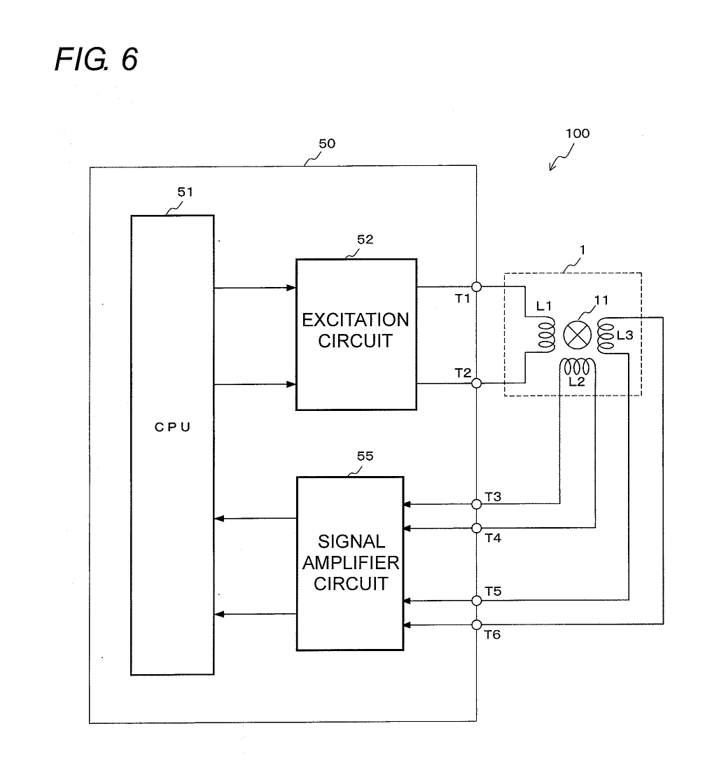

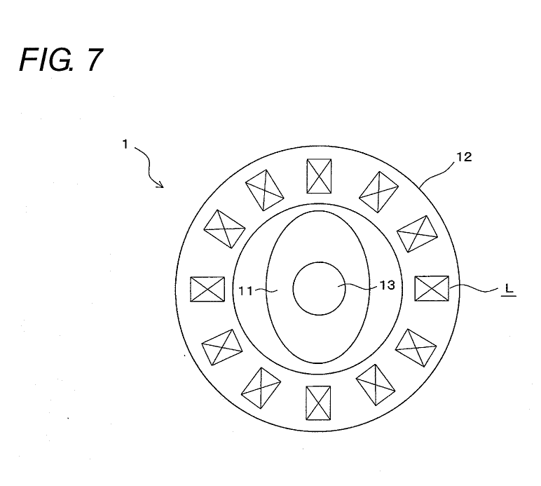

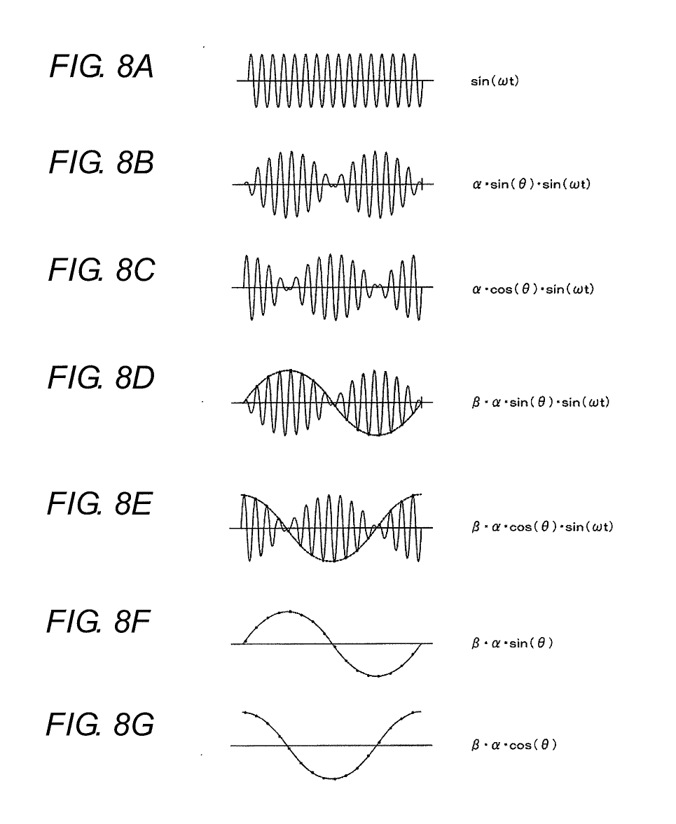

FIG. 1 is a block diagram of a rotational angle detection device according to a first embodiment of the present invention. A rotational angle detection device 100a is composed of a resolver 1 and a control unit 10a. The resolver 1 is the same as that described with reference to FIGS. 6 and 7, and accordingly, a description thereof is omitted here, and a description is made below of details of the control unit 10a.

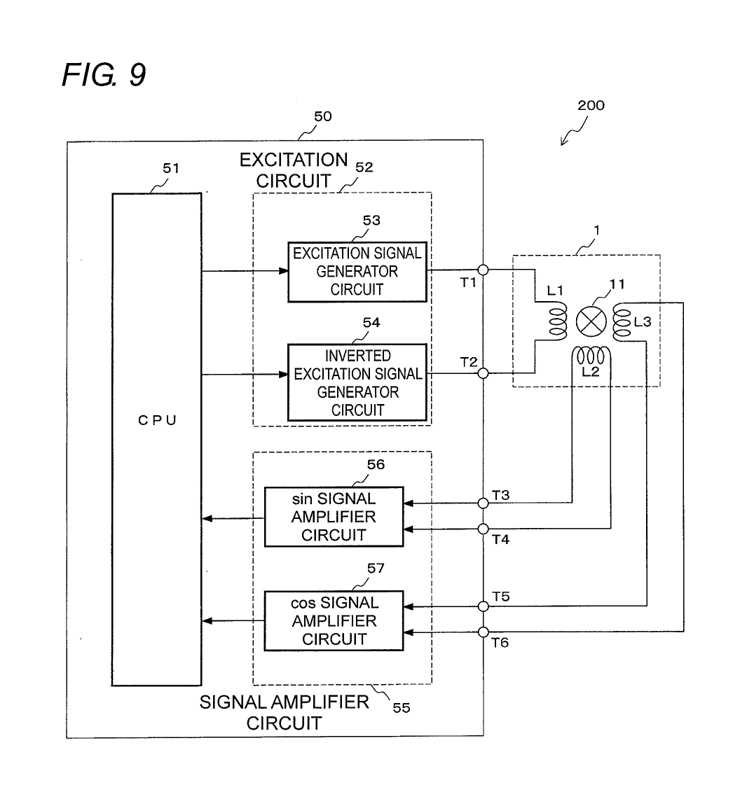

The control unit 10a includes an excitation signal generator circuit 53, a signal amplifier circuit 55 and a CPU 30a. In the control unit 10a, the inverted excitation signal generator circuit 54 of FIG. 9 is not provided, and only the excitation signal generator circuit 53 is provided. In other words, this rotational angle detection device 100a is a rotational angle detection device of a single excitation mode, which generates a single excitation signal by using the one excitation signal generator circuit 53.

An output (excitation signal) of the excitation signal generator circuit 53 is given to one end of an excitation coil L1 through a terminal T1. Other end of the excitation coil L1 is connected to the ground (that is, is grounded) through a terminal T2. One end of an output coil L2 is inputted through a terminal T3 to a sin signal amplifier circuit 56 in the signal amplifier circuit 55. Other end of the output coil L2 is connected to the ground through a terminal T4. One end of an output coil L3 is inputted through a terminal T5 to a cos signal amplifier circuit 57 in the signal amplifier circuit 55. Other end of the output coil L3 is connected to the ground through a terminal T6.

The CPU 30a includes a sampling processing unit 31, an offset correction unit 32a, and an angle calculation unit 33. These blocks are represented as functional blocks, and such functions of the respective blocks are actually realized by software processing of the CPU 30a. The offset correction unit 32a has an offset correction value storage unit 34, an arithmetic operator 35 and an arithmetic operator 36. The CPU 30a composes a rotational angle calculation unit in one or more embodiments of the present invention.

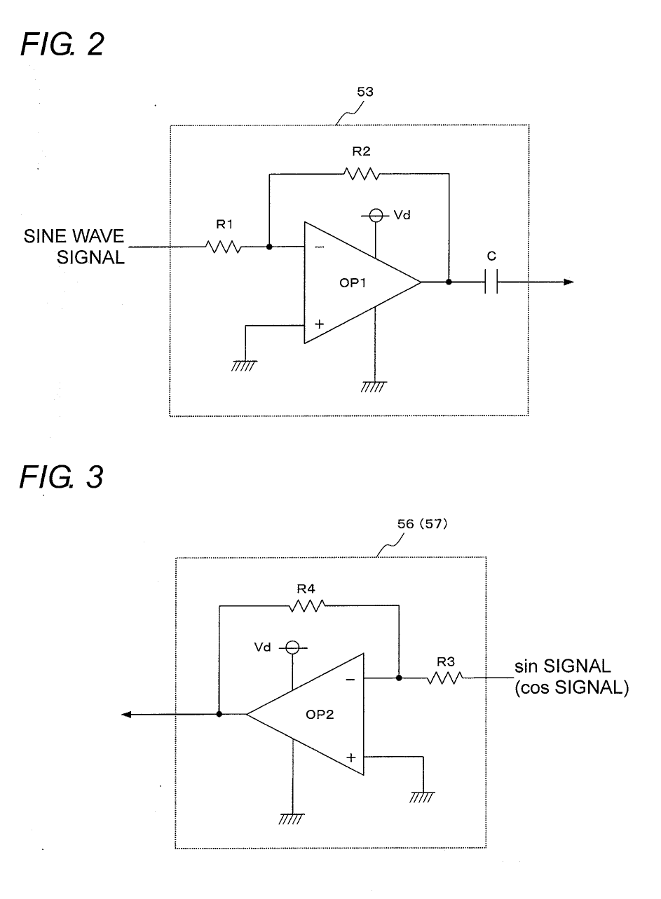

FIG. 2 shows a specific circuit example of the excitation signal generator circuit 53. The excitation signal generator circuit 53 includes: an operational amplifier OP1; a resistor R1 connected to an inverted input terminal (−terminal) of this operational amplifier OP1; a resistor R2 connected between an output terminal of the operational amplifier OP1 and the inverted input terminal thereof; and a capacitor C connected to the output terminal of the operational amplifier OP1. A non-inverted input terminal (+terminal) of the operational amplifier OP1 is connected to the ground. Reference symbol Vd denotes a direct current power supply of the operational amplifier OP1. To the inverted input terminal of the operational amplifier OP1, a sine wave signal is inputted from the CPU 30a through the resistor R1. The operational amplifier OP1 outputs an excitation signal, which is generated based on this sine wave signal, through the capacitor C to the excitation coil L1.

FIG. 3 shows a specific circuit example of the sin signal amplifier circuit 56. A configuration of the cos signal amplifier circuit 57 is similar to that of the sin signal amplifier circuit 56. The sin signal amplifier circuit 56 includes: an operational amplifier OP2; a resistor R3 connected to an inverted input terminal (−terminal) of this operational amplifier OP2; and a resistor R4 connected between an output terminal of the operational amplifier OP2 and the inverted input terminal thereof. A non-inverted input terminal (+terminal) of the operational amplifier OP2 is connected to the ground. Reference symbol Vd denotes a direct current power supply of the operational amplifier OP2. To the inverted input terminal of the operational amplifier OP2, a sin signal is inputted from the output coil L2 through the resistor R3. The operational amplifier OP2 amplifies this sin signal, and outputs the amplified sin signal to the CPU 30a.

Operations of the rotational angle detection device 100a configured as described above are basically similar to the operations described with reference to FIG. 6 except for the detection method of the rotational angle in the CPU 30a. A description will be made later in detail of the detection of the rotational angle in the CPU 30a.

Incidentally, in the case of adopting the single excitation mode, only the excitation signal generator circuit 53 just needs to be provided as the excitation circuit, and accordingly, a circuit configuration is simplified. However, meanwhile, offsets occur in the sin signal and the cos signal, and accordingly, required are countermeasures for avoiding an occurrence of an error in a detection angle owing to this offset. A description is made below of this matter.

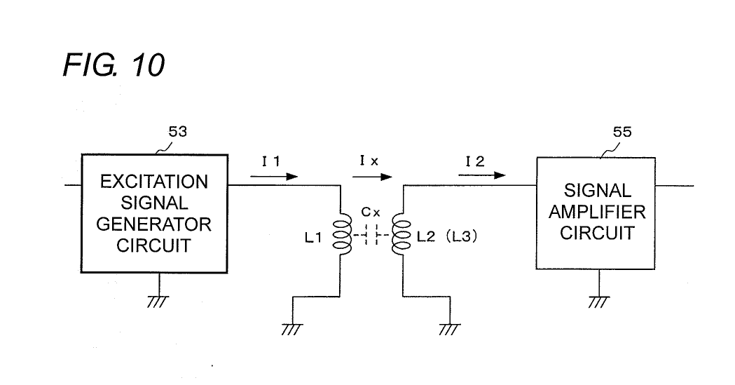

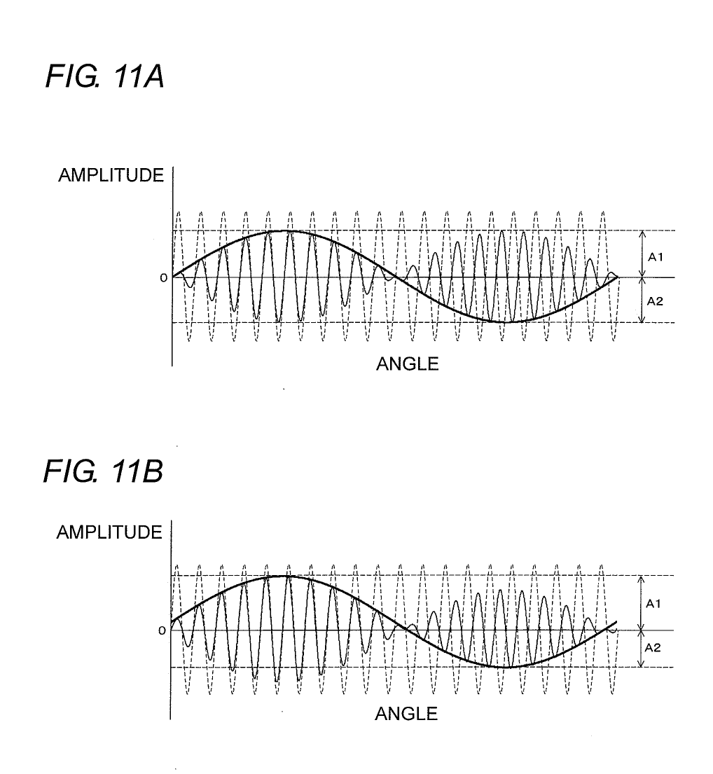

In the case of the single excitation mode, as shown in FIG. 1 the primary-side excitation coil L1 and the secondary-sides output coils L2 and L3 are connected to the common ground. When the ground is common as described above, then as shown in FIG. 10, a line capacity Cx present between the excitation coil L1 and the output coils L2 and L3 becomes a problem. Specifically, part of a current I1 flowing through the primary side of the resolver 1 flows to the secondary side through the line capacity Cx as shown by reference symbol Ix, and affects a current I2 that is based on a secondary-side induced voltage. Therefore, the offsets occur in the sin signal and the cos signal, which are to be outputted from the output coils L2 and L3. A description is made more in detail of the offsets with reference to FIGS. 11 to 13.

FIGS. 11A and 11B show waveforms of the sin signals (thin solid lines) to be outputted from the output coil L2 and waveforms of sampling signals (thick solid lines) thereof. FIG. 11A shows the waveforms in the case of the double excitation mode (FIG. 9), and FIG. 11B shows the waveforms in the case of the single excitation mode (FIG. 1). Broken lines in the drawings are a waveform of the excitation signal to be given to the excitation coil L1.

In the case of the double excitation mode, the line capacity between the excitation coil and the output coil does not become a problem, and accordingly, the offset does not occur in the sin signal. Accordingly, in FIG. 11A, A1 becomes equal to A2 (A1=A2), and the sin signal and the sampling signal become symmetrical between a + side and a − side with respect to an amplitude of 0. As opposed to this, in the case of the single excitation mode, the current of the excitation coil L1 affects the output of the output coil L2 owing to the line capacity Cx mentioned above, and accordingly, as shown in FIG. 11B, when the sin signal and the excitation signal (broken line) are in the same amplitude direction, the amplitude of the sin signal becomes large. Meanwhile, when the sin signal and the excitation signal are in amplitude directions reverse to each other, the amplitude of the sin signal becomes small. Accordingly, in FIG. 11B, A1 becomes larger than A2 (A1>A2), and the sin signal and the sampling signal become unsymmetrical between the + side and the − side with respect to the amplitude of 0. In this case, a difference between A1 and A2 (A1−A2) becomes the offset. The same also applies to the cos signal.

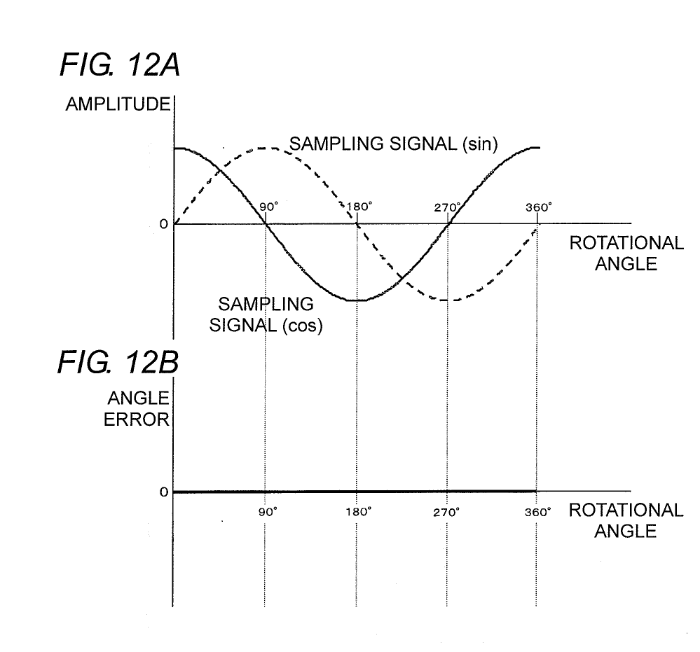

FIGS. 12A and 12B are views explaining an angle error in the case of the double excitation mode. FIG. 12A shows waveforms of the sampling signals, and FIG. 12B shows an angle error. In the double excitation mode, the offset does not occur in the sampling signals, and accordingly, the angle error does not occur as shown in FIG. 12B.

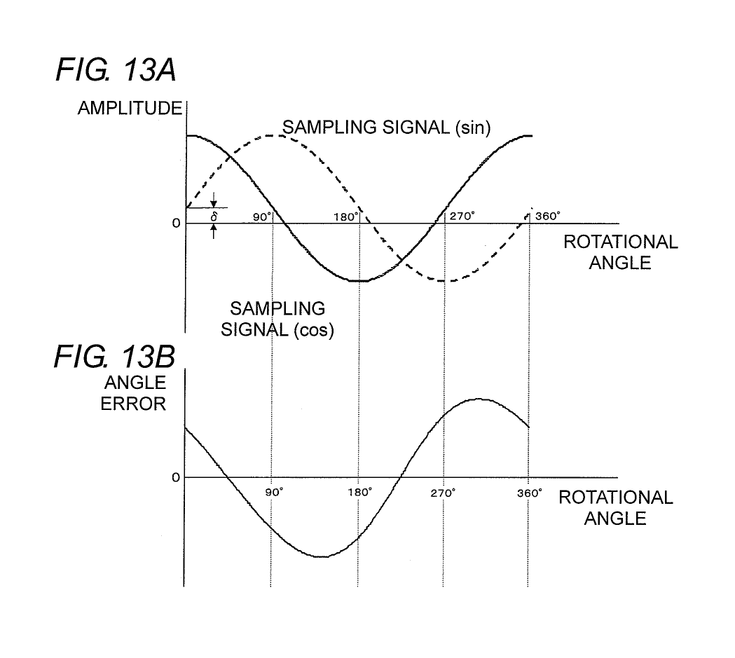

FIGS. 13A and 13B are views explaining an angle error in the case of the single excitation mode. FIG. 13A shows waveforms of sampling signals, and FIG. 13B shows an angle error. In the single excitation mode, offsets δ occur in the sampling signals, and accordingly, an angle error occurs as shown in FIG. 13B. This angle error is changed in response to the rotational angle of the rotor 11.

As described above, in the rotational angle detection device of the single excitation mode, error occurs in the detection angle based on the offsets which occur in the outputs (sin signal, cos signal) of the resolver. Accordingly, in the rotational angle detection device 100a of this embodiment, the error is not allowed to occur in the detection angle by the offset correction unit 32a provided in the CPU 30a even if there are offsets in the outputs of the resolver 1.

A description is made below in detail of a detection procedure for the rotational angle in the rotational angle detection device 100a.

The excitation signal generator circuit 53 generates the excitation signal based on the sine wave signal outputted from the CPU 30a, and gives this excitation signal to the excitation coil L1 of the resolver 1. The excitation signal Vi at this time is represented by:

Vi=sin(ωt) (1)

By the rotation of the rotor 11, the sin signal (shown as Vs1) is outputted from the output coil L2, and the cos signal (shown as Vc1) is outputted from the output coil L3. However, owing to the offsets mentioned above, these signals Vs1 and Vc1 contain an offset term δ as in the following arithmetic expressions.

Vs1=G·(sin(θ)+δ)·sin(ωt) (2)

Vc1=G·(cos(θ)+δ)·sin(ωt) (3)

Here, reference symbol G denotes a signal transformation ratio of the resolver 1, and reference symbol θ denotes the rotational angle of the rotor 11 (rotation shaft 13).

The sin signal Vs1 is amplified by the sin signal amplifier circuit 56 of the signal amplifier circuit 55. An output Vs2 of the sin signal amplifier circuit 56 becomes:

Vs2=β·Vs1=β·G·(sin(θ)+δ)·sin(ωt) (4)

β is an amplification factor of the sin signal amplifier circuit 56. Moreover, the cos signal Vc1 is amplified by the cos signal amplifier circuit 57 of the signal amplifier circuit 55. An output Vc2 of the cos signal amplifier circuit 57 becomes:

Vc2=β·Vc1=β·G·(cos(θ)+δ)·sin(ωt) (5)

The respective amplified signals are inputted to the sampling processing unit 31 of the CPU 50a.

The sampling processing unit 31 performs the sampling for the signals Vs2 and Vc2 in a predetermined cycle, and detects amplitude values of the signals at every sampling point of time. As a result, from the signal Vs2, there is extracted a sampling signal represented by:

Vs3=β·G·(sin(θ)+δ) (6)

and from the signal Vc2, there is extracted a sampling signal represented by:

Vc3=β·G·(cos(θ)+δ) (7)

These sampling signals are inputted to the offset correction unit 32a.

In the offset correction unit 32a, in the offset correction value storage unit 34, a correction value for correcting the offsets δ is stored in advance. This correction value is set in the offset correction value storage unit 34 at the time when the device is shipped from a factory. By using this correction value, the offset correction unit 32a performs, by the arithmetic operator 35, processing for deleting the offset term δ contained in the sampling signal Vs3 (arithmetic expression (6)) to be outputted from the sampling processing unit 31. As a result, an output Vs4 of the arithmetic operator 35 becomes:

Vs4=β·G·(sin(θ)) (8)

Moreover, by using the correction value, the offset correction unit 32a performs, by the arithmetic operator 36, processing for deleting the offset term δ contained in the sampling signal Vc3 (arithmetic expression (7)) to be outputted from the sampling processing unit 31. As a result, an output Vc4 of the arithmetic operator 36 becomes:

Vc4=β·G·(cos(θ)) (9)

The outputs Vs4 and Vc4 of the arithmetic operators 35 and 36 are inputted to the angle calculation unit 33.

Based on Vs4 and Vc4, the angle calculation unit 33 arithmetically operates an amplitude ratio of these signals, that is, Vs4/Vc4=sin(θ)/cos(θ)=tan (θ). Then, based on a result of this arithmetic operation, the rotational angle θ is detected from:

θ=tan⁻¹[sin(θ)/cos(θ)] (10)

As described above, in the first embodiment, the offset correction value storage unit 34 is provided in the offset correction unit 32a, and by the correction value to be outputted therefrom, the offset correction for the sin signal and the cos signal, which are to be outputted from the output coils L2 and L3, is performed. Therefore, the signals to be inputted to the angle calculation unit 33 become those from which the offsets are removed as in the arithmetic expression (8) and the arithmetic expression (9). Hence, even in the case of adopting the single excitation mode, the angle calculation unit 33 can detect an accurate rotational angle θ based on the arithmetic operation (10) without being affected by the offsets.

Moreover, the offset correction value is set in the offset correction value storage unit 34 in advance, and accordingly, it is not necessary to arithmetically operate and calculate the correction value every time, and the processing in the angle calculation unit 33 is reduced.

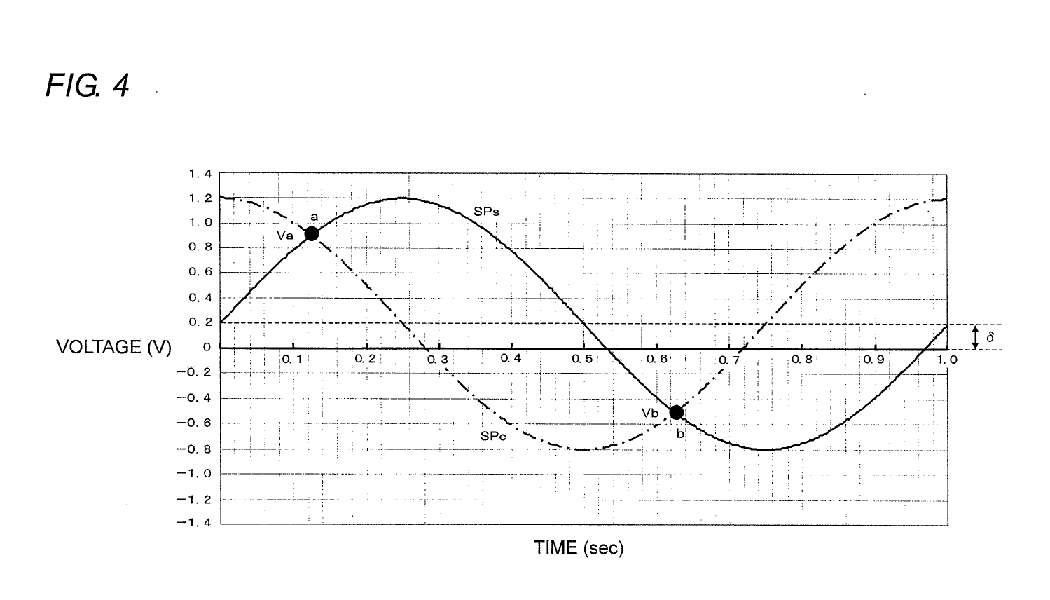

Next, a description is made of an example of a decision method of the offset correction value with reference to FIG. 4. FIG. 4 is a graph showing changes, in one cycle, of a sampling signal SPs obtained from the sin signal and a sampling signal SPc obtained from the cos signal. An axis of abscissas represents a time, and an axis of ordinates represents a voltage (amplitude value). Reference symbol δ denotes the offset.

As can be seen from FIG. 4, the respective sampling signals SPs and SPc intersect each other twice during one cycle. Points of such intersection are a point a and a point b in FIG. 4. At the point a (first timing), an amplitude value of the sampling signal SPs and an amplitude value of the sampling signal SPc become equal to each other, and also at the point b (second timing), the amplitude values of the respective sampling signals SPs and SPc become equal to each other. In the case where the amplitude value of the point a is Va (first amplitude value), and the amplitude value of the point b is Vb (second amplitude value), the offset δ becomes:

δ=(Va+Vb)/2 (11)

In order to remove this offset δ, the offset correction value γ just needs to be equalized to δ (γ=δ). Accordingly, based on the arithmetic expression (11), the offset correction value γ becomes:

γ=(Va+Vb)/2 (12)

Hence, an average value of the amplitude values Va and Vb at the points a and b is calculated, whereby an optimal offset correction value γ for deleting the offset δ can be acquired.

In order to obtain the offset correction value γ, there is also such a method for calculating an average value between a maximum value and minimum value of the sampling signals besides the method described above (for example, refer to Japanese Unexamined Patent Publication No. 2004-45286). However, in accordance with this method, the changes of the signals must be tracked, and the maximum value and the minimum values must be detected, and accordingly, arithmetic operation processing becomes complicated. Moreover, it takes a time to detect the maximum value and the minimum value, and it becomes difficult to perform high-speed processing. As opposed to this, in accordance with the method of FIG. 4, the points at which the amplitudes of the respective sampling signals SPs and SPc become equal to each other just need to be detected, and accordingly, it becomes easy to perform the arithmetic operation processing, and it becomes possible to perform the high-speed processing.

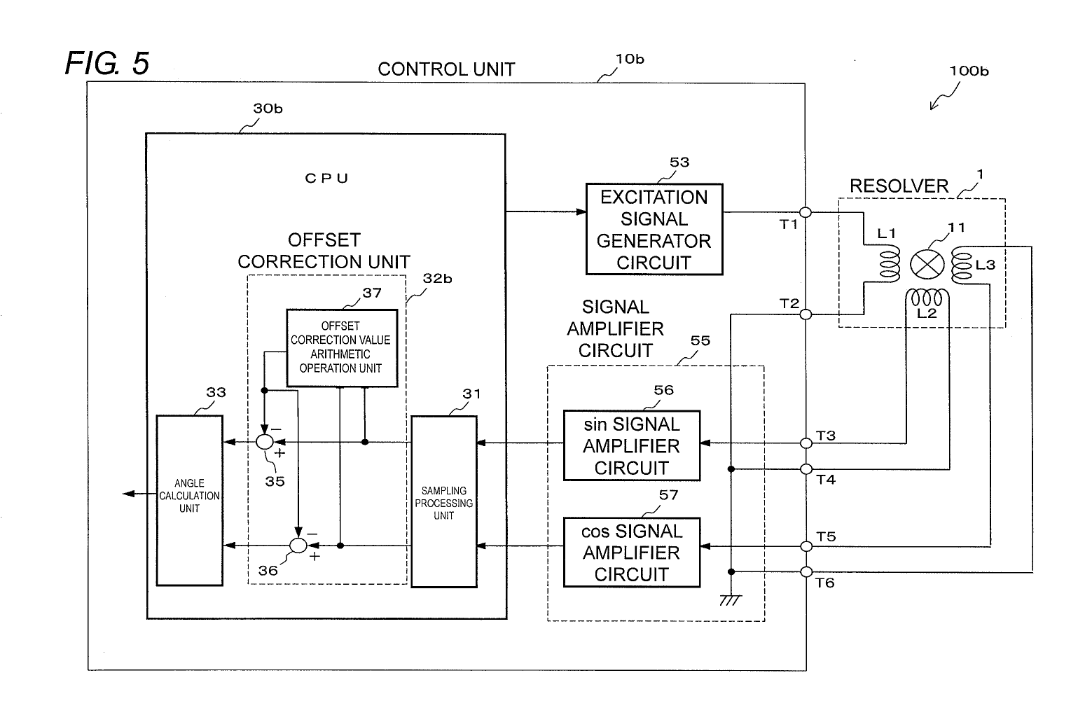

FIG. 5 is a block diagram of a rotational angle detection device according to a second embodiment of the present invention. A rotational angle detection device 100b is composed of a resolver 1 and a control unit 10b. The resolver 1 is the same as that described with reference to FIGS. 6 and 7, and accordingly, a description thereof is omitted here. Moreover, an excitation signal generator circuit 53 and a signal amplifier circuit 55 in the control unit 10b are the same as those in FIG. 1, and a description thereof is also omitted. A description is made below of a CPU 30b.

In an offset correction unit 32b of the CPU 30b, an offset correction value arithmetic operation unit 37 is provided in place of the offset correction value storage unit 34 shown in FIG. 1. Other configurations of the CPU 30b are the same as those of the CPU 30a of FIG. 1. The offset correction value arithmetic operation unit 37 arithmetically operates an offset correction value based on the respective sampling signals to be outputted from a sampling processing unit 31. This offset correction value can also be arithmetically operated by the method described with reference to FIG. 4. Then, the offset correction value arithmetic operation unit 37 outputs the arithmetically operated offset correction value to the arithmetic operator 35 and the arithmetic operator 36. Operations which follow are similar to those in the case of FIG. 1.

As described above, in the second embodiment, the offset correction value arithmetic operation unit 37 is provided in the offset correction unit 32b, and by the correction value arithmetically operated by this offset correction value arithmetic operation unit 37, the offset correction for the sin signal and the cos signal, which are to be outputted from the output coils L2 and L3, is performed. Accordingly, the signals to be inputted to an angle calculation unit 33 become those from which the offsets are removed as in the arithmetic expressions (8) and (9). Hence, even in the case of adopting the single excitation mode, the angle calculation unit 33 can detect the accurate rotational angle θ based on the arithmetic operation (10) without being affected by the offsets.

Moreover, the offset correction value is obtained by the arithmetic operation in the offset correction value arithmetic operation unit 37, and accordingly, it is not necessary to store the correction value in the storage unit in advance. Furthermore, the offset correction value is not a fixed value, but is updated in real time based on the outputs from the sampling processing unit 31. Accordingly, the offsets can be removed more effectively, and accuracy in the angle detection is enhanced.

In the present invention, a variety of embodiments can be adopted besides those mentioned above. For example, though the example where the offset correction value storage unit 34 is provided in the inside of the CPU 30a has been illustrated in FIG. 1, the offset correction value storage unit 34 may be provided in a memory on the outside of the CPU 30a.

Moreover, in the above-described embodiments, the circuit shown in FIG. 2 is mentioned as an example of the excitation signal generator circuit 53, and the circuit in FIG. 3 is mentioned as an example of each of the sin signal amplifier circuit 56 and the cos signal amplifier circuit 57; however, these circuits are merely examples, and other circuits may be adopted.

Moreover, in FIG. 4, the average value of the respective amplitude values at the two points of intersection of the sampling signals SPs and SPc is calculated, and this average value is used as the offset correction value; however, this does not hinder adoption of the above-mentioned method for calculating the offset correction value from the maximum value and minimum value of the sampling signals.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A rotational angle detection device comprising:
a resolver in which an excitation coil, a first output coil and a second output coil are provided on a periphery of a rotor coupled to a rotation shaft;
an excitation signal generator circuit that generates an excitation signal and sends the excitation signal to the excitation coil; and
a rotational angle calculation unit that performs sampling for respective output signals of the first output coil and the second output coil in a predetermined cycle, and calculates a rotational angle of the rotation shaft based on two sampling signals obtained as a result of the sampling,
wherein the excitation signal generator circuit is of a single excitation mode and generates a single excitation signal,
wherein the rotational angle detection device further comprises an offset correction unit that corrects, for the respective sampling signals, offsets contained in the respective output signals of the first output coil and the second output coil, and
wherein the rotational angle calculation unit calculates the rotational angle based on the respective sampling signals in which the offsets are corrected by the offset correction unit.

2. The rotational angle detection device according to claim 1, wherein the offset correction unit includes a storage unit in which an offset correction value for correcting the offsets is stored in advance.

3. The rotational angle detection device according to claim 1, wherein the offset correction unit includes an arithmetic operation unit that arithmetically operates an offset correction value for correcting the offsets.

4. The rotational angle detection device according to claim 2, wherein the offset correction value is an average value of a first amplitude value at first timing when amplitudes of the two sampling signals become equal to each other and a second amplitude value at second timing when the amplitudes of the two sampling signals become equal to each other.

5. The rotational angle detection device according to claim 3, wherein the offset correction value is an average value of a first amplitude value at first timing when amplitudes of the two sampling signals become equal to each other and a second amplitude value at second timing when the amplitudes of the two sampling signals become equal to each other.
